(19) United States
(12) Patent Application Publication
(10) Pub. No.: US 2009/0291298 A1
(43) Pub. Date: Nov. 26, 2009

(54) MULTILAYER FILM FOR FLEXIBLE PACKAGING

(75) Inventors: Christophe ROBERT, Thourotte (FR); Jean-Francois CHARTREL, Cuts (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: BOSTIK S.A., COURBEVOIE (FR)

(21) Appl. No.: 12/471,207

(22) Filed: May 22, 2009

(30) Foreign Application Priority Data
May 22, 2008 (FR) FR 08.02773

(51) Int. Cl. B32B 27/32; B32B 37/00

(52) U.S. Cl. 428/336; 156/324

(57) ABSTRACT

1) Multilayer film comprising 2 thin layers joined by a layer, having a thickness of less than 10 μm, of an adhesive composition comprising:
from 30 to 70% of a blend of styrene block copolymers consisting of 5 to 75% of a triblock copolymer chosen from the group comprising SIS, SIBS, SBS, SEBS and SEPS; and 25 to 95% of a diblock copolymer chosen from the group comprising SI, SBI, SIB, SB, SEB, SEP, the overall content of styrene units of said blend being between 10 and 40%; and
from 30 to 70% of one or more tackifying resins.

2) Method of preparing said film comprising a step of coating a first thin layer of material with the adhesive composition, in which said composition, rendered flowable by heating at an appropriate temperature, is extruded by a coating device without contact with said thin layer, in the form of a substantially continuous layer, which is then brought into contact with the surface of said thin layer.

One subject of the present invention is a multilayer film (or laminate) that can be used, in particular, in the field of flexible packaging, which comprises at least two thin layers of material joined together by a layer of an adhesive composition based on a styrene block copolymer. It also relates to a laminating process suitable for the manufacture of said film.

### BACKGROUND OF THE INVENTION

Flexible packaging intended to package a wide range of products, such as those manufactured by the agri-food, cosmetics or detergent industries, are generally composed of several thin layers or substrates (in the form of foils or films), the thickness of which is between 5 and 150 μm and which are composed of various materials such as paper, aluminium or thermoplastic polymers such as polyethylene (PE), oriented or non-oriented polypropylene (PP), ethylene/vinyl acetate copolymers (EVA). The corresponding multilayer film, the thickness of which may vary from 20 to 400 μm, makes it possible to combine the properties of the various individual layers of material and to thus offer the consumer a set of characteristics suited to the final flexible packaging such as for example: its visual appearance (especially that of the printed elements presenting information concerning the packaged product and intended for the consumer), a barrier effect to atmospheric moisture or to oxygen, food contact without risk of toxicity or modification of the organoleptic properties of the packaged foodstuffs, chemical resistance for certain products such as ketchup or liquid soap, good resistance to high temperature (for example in the case of sterilization) or on the other hand to very low temperature (deep-freezing). In order to constitute the final packaging, the multilayer film is generally formed by heat sealing, at a temperature that varies from around 120 to 250° C., that latter technique also being used for sealing the packaging around the product intended for the consumer.

The various layers of material that make up the multilayer film are combined or assembled by laminating during a manufacturing operation known as lamination which uses adhesives and devices or machines designed for this purpose. The multilayer film thus obtained is often itself described by the terms laminate or composite.

The multilayer films that can be used for manufacturing flexible packaging generally bear, at least on one portion of their surface, printed components that present the information regarding the packaged product. These printed components result from the deposition of various inks, via a printing process, onto one of the thin layers, which is made up of a transparent material, prior to the laminating operation. This laminating operation is then carried out so that, in the final multilayer film, said deposition is in contact with the adhesive, the printed components thus being protected from the outside environment by the thin transparent layer.

The laminating adhesives may sometimes be, in industrial practice, in the form of aqueous-based adhesives (for example of casein or acrylic type) but are very generally polyurethane-type adhesive compositions.

The latter adhesives are used by industrialists specialized in lamination (often known as laminators) in machines that operate continuously with line speeds that are generally high and in which both the films that make up the individual layers and the final laminate film are, due to their very large sizes, packaged by winding in the form of wide reels, the width of which may range up to around 2 m and the diameter up to 1.80 m. The reel of final composite film, on which the information components of the future packaging are generally printed, is often known as the mother reel.

The laminating processes generally used industrially with polyurethane-type adhesives firstly comprise a step of coating adhesive over a first film of material, which consists of a deposition over the whole of its surface of a continuous layer of adhesive of controlled thickness, corresponding to an amount of adhesive (or coating weight) that is also controlled. This coating step is followed by a step of laminating a second film of material, identical to or different from the first, consisting of the application, under pressure, of this second film to the first film covered with the layer of adhesive.

In the coating step, the continuous layer of adhesive is deposited, at a temperature that varies, depending on the case, from ambient temperature up to about a hundred degrees, at the end of a transfer that results from the pressurized contacting of one rotating roll, previously loaded with adhesive, with the film of material to be coated. In the laminating step, the pressure necessary for the application of the second film onto the film coated with adhesive is generally exerted by passing the corresponding films between 2 rolls. The coating and laminating steps are carried out continuously in one and the same laminating installation.

The laminate thus obtained generally comprises an amount of polyurethane-type adhesive of less than 10 g/m² (corresponding to a continuous layer having a thickness that does not exceed around 10 μm) and generally of less than 5 g/m². The laminate films manufactured according to this type of process are particularly suitable for the manufacture of flexible packaging due to their excellent cohesion. This cohesion is also maintained during the forming of the film in order to make the flexible packaging, especially after heat sealing. Furthermore, the very small thickness of this adhesive layer advantageously makes it possible to maintain the flexible and often transparent nature of the films of materials necessary for making flexible packaging.

The laminating operation itself is very often followed by an operation of cutting the composite film, which is also carried out by the laminator, so as to generate, from a mother reel, several daughter reels of smaller width, for example between 10 cm and 1 m.

These daughter reels are intended to be transported and delivered to the various industrialists that are clients of the laminators, who use them directly in their packaging lines to package their own products, for example agri-food, cosmetic or detergent products, which are intended, in particular, for the consumer.

Continuous industrial laminating processes that use polyurethane-type adhesives advantageously permit a high productivity, ranging up to in-line composite film production rates of 450 m/minute, or even higher.

The polyurethane-type laminating adhesives encountered in practice are historically solvent-based and are in the form of “two-component” or “one-component” systems.

“Two-component” systems are supplied to the laminator in the form of 2 organic solutions containing chemical species which are generally, at least for one of the 2 solutions, polyurethane or polyester polymers (having a molecular weight of around 1000 to 30000 Da), the other solution possibly containing simple molecules. These chemical species bear, for one of the solutions, terminal isocyanate groups and, for the other solution, terminal hydroxyl groups. Mixing of the 2 solutions is carried out by the laminators prior to starting up the laminating machine. During the operation of the machine, after coating with the mixture thus obtained and before laminating, the solvent is evaporated. At the end of these evaporation and laminating steps, the isocyanate groups of one of the species react with the hydroxyl groups of the other species, according to a reaction known as crosslinking, in order to form a three-dimensional network having urethane bonds which ensures the cohesion of the bond between the two laminated thin layers. The time required to carry out this crosslinking reaction is however very long, of around 3 to 7 days in order to ensure the required cohesion.

“One-component” systems are supplied to the laminator in the form of a single organic solution containing a polyurethane polymer having terminal isocyanate groups and a molecular weight of around 10 to 30 kDa. The cohesion of the adhesive layer (or bond) between the 2 laminated thin layers of material is achieved after completion of a three-dimensional network having urethane and/or urea bonds that results from a crosslinking reaction between the terminal isocyanate groups and the water which is present in the form of atmospheric moisture or else of moisture in the material of the layers to be assembled. In this case also, the time required to complete this crosslinking reaction is very long, of around 3 to 7 days in order to ensure the required cohesion.

An improvement in this laminating process results from the elimination of the solvent evaporation step, which is made possible by the use of solvent-free polyurethane-type adhesives.

These adhesives are polyurethanes having a molecular weight between around 1 and 20 kDa.

This type of adhesive, like the previous type, may be in the form of “two-component” or “one-component” systems. In both cases, after depositing the adhesive on the thin layer of material to be coated and laminating with the second thin layer of material, the cohesion of the bond between the 2 layers also requires the completion of a three-dimensional network (having urethane and urea bonds) that results from a crosslinking reaction between terminal isocyanate and hydroxyl groups. Also for this type of adhesive, the time required to complete this crosslinking reaction is very long, possibly ranging up to 2 weeks in the case of two-component solvent-free polyurethane-type adhesives.

The length of the crosslinking time associated with polyurethane-type adhesives leads to drawbacks relating to the organization of the industrial production of laminators. It is thus necessary to have storage spaces for the storing the mother reels of composite film either at ambient temperature or at a temperature above ambient temperature, for a time of several days to 2 weeks, necessary for the completion of the crosslinking. Added to this drawback is that of having to wait for the at least partial completion of the crosslinking reaction in order to be able to take up the mother reels and convert them, via cutting, to daughter reels.

Another drawback of polyurethane-type adhesives regards the use of composite films laminated by them for the production of flexible packaging intended for food products. This is because this type of adhesive may contain certain amounts of small aromatic molecules having a diisocyanate group which originate from unreacted monomers during the manufacture of the polyurethanes. These small molecules are capable of migrating through the layers of flexible packaging and of coming into contact with the food products in order to react with the moisture contained in the latter and form aromatic primary amines that are well known for their toxicological health risks. In order to control this risk, the amount of these amines is maintained below a certain upper safety limit, set by certain legislations, the amount of these amines being evaluated by tests carried out under standard conditions. These tests are carried out both during the development of the adhesive in the laboratory and, randomly, on samples of the product manufactured industrially. The presence of aromatic primary amines may be completely avoided by using polyurethanes obtained from aliphatic diisocyanate monomers, but in this case the crosslinking of the adhesive requires a particularly long time, up to 7 or 10 days, and must be carried out at a temperature above ambient temperature.

Adhesives other than those of polyurethane type, and processes that use them have been proposed, for the purpose of manufacturing complex (or multilayer) films.

Application WO 02/064694 thus describes a three-layer thermoplastic film comprising a layer having a thickness of 20 μm composed of an adhesive composition that comprises a copolymer having polystyrene and polyisoprene blocks, and also a tackifying resin. This three-layer film is inevitably manufactured by blown-film coextrusion, the adhesive layer allowing the manufacture of packages that are easy to open and reclose of the “repositionable” type. Such a laminate film is not however suitable, due to its manufacturing process, for the presence of printed components that present information relating to the packaged product. Specifically, it does not make it possible to obtain, on the face of a transparent thin layer, a deposition of inks which is in contact with the adhesive layer.

International Application WO 96/25902 furthermore describes a coating process that aims to deposit on a first substrate a substantially continuous layer of a molten thermoplastic composition, in particular of a hot-melt adhesive, which allows the application of very low coating weights of this composition, for example of less than 10 g/m². This coating process is carried out, in particular, in order to laminate a second substrate to the first, thus coated substrate.

Hot-melt adhesives (or “HMs”) are substances that are solid at ambient temperature which contain neither water nor solvent. Applied in the molten state, they solidify during cooling thus very rapidly forming a joint that ensures the cohesion of the substrates (or films) to be bonded in the laminate.

According to the coating process described by Application WO 96/25902 (often denoted by the name “curtain coating”), the thermoplastic composition, rendered flowable at an appropriate temperature, is produced in the form of a continuous film by a coating device, for example a lip (or slot) nozzle, which is not in contact with the substrate to be coated. The continuous film (in the form of a curtain) thus produced therefore travels through the air for a certain distance, ranging from 0.5 mm to around 20 mm, before being deposited onto the substrate to be coated.

Application WO 99/28048 describes, in one embodiment, an improvement of the process from the preceding application consisting in the application of a pressure to the layer of thermoplastic composition coating the substrate, exerted by means of a roll, the exterior of which is provided with a non-stick coating.

However, the adhesives actually taught by the latter 2 applications are used with a coated substrate productivity that does not exceed 70 m/minute.

### DETAILED DESCRIPTION

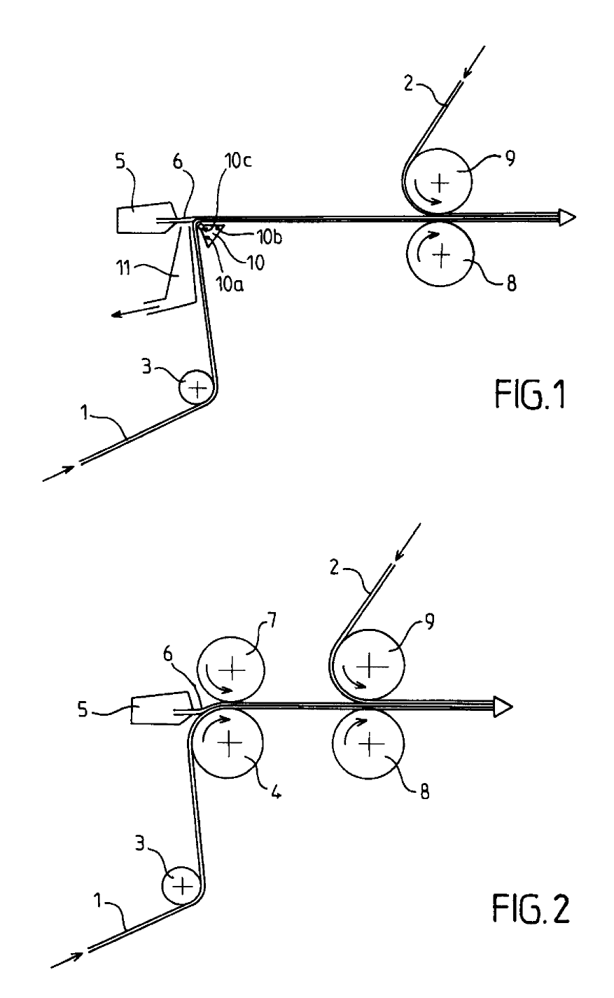

FIG. 1 schematically describes an embodiment of the laminating process.

FIG. 2 schematically describes a second embodiment of the laminating process.

One feature of the invention is to provide a laminate film comprising a substantially continuous layer having a thickness of less than 10 μm of an adhesive of a type other than polyurethane, and that offers a cohesion quality of the same level, said laminate film possibly also being manufactured by a process comprising a coating step and that provides a line speed of at least 100 m/minute.

Another feature of the present invention is to provide a composite film comprising a laminating adhesive that does not use a reactive polyurethane and is consequently free of the corresponding toxicological constraints.

Another feature of the present invention is to provide a composite film comprising a laminating adhesive that enables the creation of a bond between at least 2 layers of said film without a crosslinking reaction.

Another feature of the present invention is to provide a composite film comprising a laminating adhesive that permits, during the manufacture of said film, the operation of cutting a mother reel into daughter reels immediately after the laminating step.

One subject of the present invention is a multilayer film (or laminate) comprising at least 2 thin layers of material joined together by a layer, having a thickness that does not exceed 10 μm, of an adhesive composition comprising:
from 30 to 70% of a blend of styrene block copolymers consisting of:
   5 to 75% of a triblock copolymer chosen from the group comprising SIS, SIBS, SBS, SEBS and SEPS; and
   25 to 95% of a diblock copolymer chosen from the group comprising SI, SBI, SIB, SB, SEB, SEP,
      the overall content of styrene units of said blend being between 10 and 40%; and
from 30 to 70% of one or more tackifying resins.

Unless indicated otherwise, the percentages used in the present text for expressing amounts correspond to weight/weight percentages.

The styrene block copolymers are composed of various polymerized monomers, including at least one polystyrene block, and are prepared by radical polymerization techniques. The triblock copolymers include 2 polystyrene blocks and one elastomer block. They may have various structures: linear, star (also known as radial), branched or else comb structures. The diblock copolymers include one polystyrene block and one elastomer block.

It has now been found that this adhesive composition is particularly suitable for the implementation of the curtain-coating process, as described by Application WO 99/28048, in the case of a substrate to be coated that travels continuously at a line speed greater than or equal to 100 m/minute.

Specifically, as a coating device for such a process, use is generally made of a lip nozzle in which the opening has a rectangular slot shape, the large side (or width) of which corresponds to the width of the substrate to be coated (which may range up to around 2 m), and the small side (or height) of which may measure, depending on the case, from 100 to 1000 μm. This slot is kept at a suitable distance from the substrate to be coated, generally between 0.5 and 20 mm.

After heating at a temperature between 140 and 210° C., and extrusion through the coating nozzle at a pressure which may range from 30 to 200 bar, preferably from 50 to 100 bar, the adhesive composition (as defined previously) has the advantage of being suitable for being produced in line in the form of a continuous layer, the thickness of which at the nozzle outlet, corresponding to the height of the slot, may vary from 100 to 1000 μm and which is progressively drawn through the air, over a distance of 0.5 to 20 mm, so as to bring said thickness to a value of less than 10 μm at one point in the vicinity of which said layer comes into contact with the substrate to be coated, which substrate is moved at a line speed greater than or equal to 100 m/minute by appropriate drive means.

This adhesive composition furthermore make it possible to obtain, without the drawbacks of polyurethane-type adhesives, laminate films that have a cohesion quality of the same level as that of these polyurethane-type adhesives. Thus, it is possible to proceed to the in-line step of cutting the mother reels into daughter reels immediately after the laminating step. Moreover, these laminate films are particularly suitable for use in the field of flexible food packaging, at least due to the absence of risk linked to the presence of toxic aromatic primary amines.

The styrene block copolymers that can be used in the adhesive composition included in the laminate film according to the invention have a weight-average molecular weight M_{w} generally between 50 kDa and 500 kDa and are composed of blocks of various polymerized monomers. The triblock copolymers have the following general formula:

ABA (I)

in which:
A represents a styrene (or polystyrene) non-elastomeric block; and
B represents an elastomer block which may be:
   polyisoprene: the block copolymer than has the structure:
   polystyrene/polyisoprene/polystyrene, and is named SIS;
   polyisoprene followed by a polybutadiene block: the block copolymer then has the structure:
   polystyrene/polyisoprene/polybutadiene/p olystyrene, and is named SIBS;
   polybutadiene: the block copolymer then has the structure:
   polystyrene/polybutadiene/polystyrene, and is named SBS;
   completely or partly hydrogenated polybutadiene: the block copolymer then has the structure: polystyrene/poly(ethylene/butylene)/polystyrene, and is named SEBS;
   completely or partly hydrogenated polyisoprene: the block copolymer then has the structure: polystyrene/poly-(ethylene/propylene)/polystyrene and is named SEPS.
The diblock copolymers have the following general formula:

A-B (II)
in which A and B are as defined previously.

When the adhesive composition comprises several triblock styrene copolymers, the latter being chosen from the group comprising SIS, SBS, SEPS, SIBS or SEBS, it is clearly understood that said triblocks may belong to a single or to several of these 5 families of copolymers.

It is preferred to use a blend of a triblock copolymer and of a diblock copolymer having the same elastomer block, in particular due to the fact that such blends are commercially available.

According to another preferred variant, the content of diblock copolymer in the blend of styrene block copolymers is between 50 and 95%.

The triblock copolymers included in the adhesive composition preferably have a linear structure, since they advantageously make it possible to obtain an even higher line speed.

Mention may be made, as examples of commercial products having a linear structure, of:
SIS: Kraton® D1113 from Kraton (blend comprising 56% of SI diblock, 44% of SIS triblock and having an overall content of styrene units of 16%);
SIBS: Kraton® MD 6465 (56% diblock and 16% styrene);
SBS: Kraton® D1118 (78% diblock and 33% styrene);
SEBS: Kraton® G1726 (70% diblock and 30% styrene).

Mention may be made, as examples of commercial products having a radial structure, of:
SIS: Vector® 4230 from ExxonMobil (30% diblock and 20% styrene).

The tackifying resin or resins that can be used in the adhesive composition included in the laminate film according to the invention have weight-average molecular weights M_{w} generally between 300 and 5000 Da and are especially chosen from:
(i) rosins of natural or modified origin, such as for example the rosin extracted from the gum of pine trees, the wood rosin extracted from the roots of the tree and derivatives thereof that are hydrogenated, dehydrogenated, dimerized, polymerized or esterified with monoalcohols or polyols such as glycerol;
(ii) resins obtained by hydrogenation, polymerization or copolymerization (with an aromatic hydrocarbon) of mixtures of unsaturated aliphatic hydrocarbons having around 5, 9 or 10 carbon atoms resulting from oil cuts;
(iii) terpene resins that generally result from the polymerization of terpene hydrocarbons such as for example monoterpene (or pinene) in the presence of Friedel-Crafts catalysts, optionally modified by the action of phenols; and
(iv) copolymers based on natural terpenes, for example styrene/terpene, α-methyl-styrene/terpene and vinyltoluene/terpene.

It is preferred to use tackifying resins that belong to the categories (ii) or (iii) for which mention may be made, as examples of a commercially available resin, of:
(ii) Escorez® 1310 LC available from Exxon Chemicals, which is a resin obtained by polymerization of a mixture of unsaturated aliphatic hydrocarbons having around 5 carbon atoms, and which has a softening point of 94° C. and an M_{w} of around 1800 Da; Escorez® 5400 also from Exxon Chemicals, which is a resin obtained by polymerization then hydrogenation of a mixture of unsaturated aliphatic hydrocarbons having around 9 or 10 carbon atoms and which has a softening point of 100° C. and an M_{w} of around 570 Da;

(iii) Sylvares® TR7115 available from Arizona Chemicals, which is a terpene resin having a softening point of 115° C. and an M_{w} of around 1040 Da.

The adhesive composition may also comprise from 0.1 to 2% of one or more stabilizers (or antioxidants). These compounds are introduced in order to protect the composition from degradation resulting from a reaction with oxygen, which is capable of developing by the action of heat, light or residual catalysts on certain raw materials such as the tackifying resins. These compounds may include primary antioxidants that trap free radicals and are generally substituted phenols such as Irganox® 1010 from CIBA. Primary antioxidants may be used alone or in combination with other antioxidants such as phosphites, for example Irgafos® 168 also from CIBA, or else with UV stabilizers such as amines.

The adhesive composition may also comprise a plasticizer, but in an amount that does not exceed 5%. It is possible to use, as a plasticizer, a paraffin and naphthene oil (such as Primol® 352 from ESSO) optionally comprising aromatic compounds (such as Nyflex 222B).

According to one preferred variant, the adhesive composition does not comprise a plasticizer.

According to another preferred variant, the adhesive composition comprises from 35 to 65% of the blend of triblock and diblock copolymers and from 35 to 65% of tackifying resin(s).

According to one most particularly preferred embodiment, use is made, as a styrene block copolymer, of an SIS of linear structure as a blend with the SI diblock.

Finally it is preferred to use, in the multilayer film (or laminate) according to the invention, an adhesive composition having a Brookfield viscosity, measured at 190° C., greater than 5000 cP, preferably greater than 10000 cP.

The adhesive composition is prepared by simple mixing of the ingredients at high temperature, between 150 and 200° C., using a blade mixer or else a twin-screw extruder.

The laminate film according to the invention comprises the adhesive composition as described previously in the form of a continuous layer having a thickness of less than 10 μm, preferably less than or equal to 5 μm, and more preferably still between 1 and 5 μm.

The layer of adhesive composition makes it possible to ensure the cohesion between two thin layers of material, the thickness of which may vary from 5 to 150 μm.

The materials are generally chosen from paper, aluminium or thermoplastic polymers such as: polyethylene (PE), oriented or non-oriented polypropylene (PP), ethylene/vinyl acetate copolymers (EVA), polyester, polyamide.

The laminate film according to the invention may comprise several layers of the preceding materials, and also several adhesive layers of the composition as defined previously. Its total thickness is capable of varying to a large extent ranging from 20 to 400 μm.

According to one preferred embodiment, one of the 2 thin layers included in the multilayer film according to the invention is composed of a transparent material and bears, on at least one part of the face that is in contact with the layer of adhesive composition, a deposition of inks, for the purposes of information regarding the packaged product. This deposition of inks is carried out by a suitable printing process on the transparent thin layer, prior to it being laminated. It is advantageously protected from the outside by the thin transparent layer. The transparent material is, for example, polyester or polypropylene. The inks used are generally dispersions, in an organic or mineral continuous phase, of very finely divided, organic or mineral insoluble pigments.

The invention also relates to a method of continuously preparing the multilayer film according to the invention, comprising:
(i) a step of coating a first thin layer of material with the adhesive composition as defined previously, in which said composition, rendered flowable by heating at an appropriate temperature, is extruded by a coating device without contact with said thin layer, in the form of a substantially continuous layer, which is then brought into contact with the surface of said thin layer; then
(ii) a step of laminating a second thin layer, onto the first thin layer coated in accordance with step (i).

The thin layer 1 is in the form of a film which is packaged by windings in a reel (not represented in the figure), the width of which corresponds to the width of said film and which is rotated by drive means (also not represented) so as to give said film a certain rate of travel, in the direction indicated by the arrow, which may range up to 450 m/minute, or even higher.

The film (or thin layer) 1 is brought by guide rolls 3 and/or 4 into the vicinity of the coating device 5, from which it remains separated by a distance between 0.5 and 20 mm, preferably between 0.5 and 2 mm. The coating device is advantageously a slot nozzle (also known as a “lip” nozzle), the slot of which has a rectangular shape for which the large side (or width) corresponds to the width of the film 1 to be coated (which may range up to around 2 m) and for which the small side (or height) may measure from 100 to 1000 μm.

The temperature at which the adhesive composition is rendered flowable may vary from 140 to 210° C., and is obtained by means of heating said composition placed, depending on the case, in a melting tank or an extruder.

The substantially continuous layer 6 of adhesive composition has, at the outlet of the slot of the lip nozzle, a thickness which corresponds substantially to the height of the slot, namely a thickness which may vary from 100 to 1000 μm. In the continuous mode of operation, said layer moves, in suspension in the air, over the distance which separates its coming into contact with the film 1 to be coated and the coating device 5.

In continuous mode, the substantially continuous layer 6 of adhesive composition is, under the effect of the force resulting from the travelling of the film, drawn so that its thickness, between 100 and 1000 μm at the outlet of the nozzle, is brought, in the vicinity of its coming into contact with the film 1, to a thickness of less than 10 μm, or even 5 μm. This difference in thickness is not represented in FIGS. 1 and 2.

According to a first embodiment, illustrated by FIG. 1, of the coating step (i) of the process according to the invention, the substantially continuous layer 6 of adhesive composition extruded by the coating device 5:
(a) crosses the space between said device and the film 1 suspended in air, the pressure of which is locally dropped to a value between 500 and 975 mbar, preferably between 750 and 900 mbar; then
(b) is brought into contact with the film 1 in the vicinity of the edge 10c formed by the two guiding surfaces 10a and 10b of a deflecting element 10 through which a compressed air duct (not represented in the figure) passes that opens via at least one outlet opening into the zone of the edge 10c, so that the compressed air forced back forms a cushion of air around said edge. The cushion of air advantageously reduces the friction between the edge 10c and the film 1 while the latter travels at high speed.

The reduction in the atmospheric pressure in the vicinity of the layer 6 suspended in air is advantageously obtained by a vacuum chamber 11 having the appropriate geometry, which is connected to a vacuum source (not represented in FIG. 1).

The 2 guiding surfaces 10a and lob of the deflecting element 10 are suitable for guiding the film 1 and for the modification of its transport direction, as indicated in FIG. 1. The film 1 passes along the feed guiding surface 10a of the deflecting element 10, its transport direction being radically modified by the edge 10c, and then passes along the discharge guiding surface lob, in the direction of the arrow. There is a cushion of air between the film 1 and the deflecting element 10, the 2 surfaces 10a and 10b being configured as surfaces having a cushion of air.

The combination of the drop in atmospheric pressure and of the deflecting element 10 is particularly advantageous, since it avoids the inclusion of air between the layer 6 of adhesive composition and the film 1, which inclusion may prove particularly troublesome for high rates of travel of the film, especially above 450 m/minute.

For the description of said deflecting element 10, reference is made to International Application WO 2005/099911.

According to a second embodiment of the coating step (i) of the process according to the invention, illustrated by FIG. 2, the substantially continuous layer 6 of adhesive composition extruded by the coating device 5 is, after it has come into contact with the film 1, pressed against the latter by a roll 7, the exterior of which is provided with a non-stick coating, for example based on polytetrafluoroethylene. Said roll 7 exerts, with the roll 4, a pressure on the adhesive layer deposited on the film 1, and thus avoids air being trapped between said film and the adhesive layer for high rates of film travel, especially above 100 m/minute, or even 450 m/minute.

For the description of this second embodiment, reference is expressly made to the aforementioned Application Wo 99/28048.

The coating step (i) included in the process according to the invention is followed by a step (ii) of laminating a second thin layer 2 of material onto the first thin layer 1 coated with the substantially continuous layer 6 of adhesive composition. This second thin layer 2 is also in the form of a film, which is also advantageously packaged, like the first one, in the form of a reel; it is composed of a material identical to or different from that used for the first thin layer 1. The laminating is carried out by applying a pressure exerted by the rolls 8 and 9.

Thus, 2 thin layers of material bonded by a layer of adhesive composition are advantageously obtained, the assembly being included in the laminate film according to the invention, as defined previously. This laminate film is also packaged as a reel.

The laminate films according to the invention can be used for manufacturing the most diverse flexible packaging, which is shaped then sealed (after the step of packaging the product intended for the consumer) by heat sealing (or heat welding).

### 180° Peel Test:

The cohesion of the composite film according to the invention is evaluated by the 180° peel test as described in French Standard NF T 54-122. The principle of this test consists of determining the force necessary to separate (or peel) 2 individual layers of film bonded by the adhesive.

A rectangular-shaped test specimen having a width of 1.5 cm and a length around 10 cm was cut from the laminate film. From the end of this test specimen, and over around 2 cm, the 2 individual layers of film included in this strip are delaminated and the 2 free ends obtained are fastened to two clamping devices connected, respectively, to a fixed part and a mobile part of a tensile testing machine which are located on a vertical axis.

While a drive mechanism gives the mobile part a uniform speed of 100 mm/minute, leading to the delamination of the 2 layers, the delaminated ends of which progressively move along a vertical axis forming an angle of 180°, the fixed part, connected to a dynamometer, measures the force withstood by the thus held test specimen.

The result is expressed in N/cm. The 180° peel test results, for a laminate film based on polyurethane adhesive, in a value customarily between 0.2 and 7 N/cm.

### 180° Peel Test on Heat-Welded Film:

The heat welding consists in assembling two parts of the thermoplastic laminate film, by bringing them to a temperature capable of varying from around 120 to 250° C. by means of the heating elements of a heat sealer (known as jaws), then in pressing them against one another, so as to allow the movement of the macromolecules of one towards the other and the entanglement thereof. This operation, which ensures the interpenetration between the 2 individual layers of the laminate film thus brought into contact over one part only of their thickness, must not undermine the quality of the cohesion of said film over the heat-welded part.

The principle of this test therefore consists in determining the force necessary to separate (or peel) 2 individual layers of the film bonded by the adhesive, over a heat-welded part of said film.

A rectangle of around 10 cm in length by 4 cm in width is cut from the laminate film and folded along its largest median. The branches of both sides of the fold are heat welded at a temperature of 140° C. and under a pressure of 2.5 bar, so as to form a heat-welded zone of 1 cm in width and 10 cm in length, using, for this, a heat sealer having smooth jaws. Next, by simple cutting a rectangular strip of 1.5 cm by 2 cm comprising the 2 composite films assembled along a heat-welded zone of 1.5 cm by 1 cm is obtained, leaving a zone of 1.5 cm by 1 cm where the 2 branches of films remain free, linked solely by the heat-welded zone.

The 2 individual layers of laminate film included in one of the 2 branches of film left free are delaminated over around 1 cm until reaching the beginning of the heat-welded zone. The 2 free ends obtained are then fastened in the two respectively fixed and mobile clamping devices of the tensile testing machine described previously, and the 180° peel test is then carried out as for the previous test.

The result customarily leads to a value, for a laminate film based on polyurethane adhesive, which is also between 0.2 and 7 N/cm and which is greater than or equal to the value obtained by the previous test, for a film that is not heat-welded.

### EXAMPLES

The following examples are given purely by way of illustrating the invention and should in no case be interpreted as limiting the scope thereof.

### Example 1

The adhesive composition indicated in Table 1 below was prepared by simple melt blending of the ingredients at 170° C., using a twin-screw extruder.

A Brookfield viscosity greater than 200000 mPa·s was measured for this composition at 190° C.

The MFI, measured at 190° C., was 50 g/10 minutes. The MFI (melt flow index) is the mass of composition placed in a vertical cylinder that flows, in 10 minutes, through a die of fixed diameter, under the effect of a pressure exerted by a loaded piston having a total weight of 2.16 kg, in accordance with the ISO 1133 standard.

This adhesive composition was used for manufacturing a composite film comprising 2 layers each composed of an oriented polypropylene film having a thickness of 20 μm and bonded together by a layer of said composition which had a thickness of around 2 μm.

A laminating machine was used to manufacture this film, the structure of which machine corresponds schematically to the device represented in FIG. 1. The 2 oriented polypropylene films were packaged as a reel having an width of 30 cm. The polypropylene reel to be coated was driven by a motor that made it possible to give the substrate a rate of travel ranging up to 600 m/minute. The coating device 5 comprised a lip nozzle sold by NORDSON under the reference BC 70, the slot of which has the shape of a rectangle having a length of 30 cm and a height of 600 μm. This nozzle was placed 1 mm away from the substrate made of a thin film to be coated.

The guiding surfaces 10a and 10b of the deflecting element 10 formed an angle of around 60°. The pressure created in the vicinity of the continuous film 6 of adhesive composition between the coating device 5 and the film 1 was maintained between 750 and 900 mbar by means of the vacuum chamber 11.

The adhesive composition was extruded by the lip nozzle at the extrusion temperature indicated in Table 1 and at a pressure between 70 and 90 bar. The lamination of the film 2 onto the film 1 thus coated was carried out by means of the rolls 8 and 9.

The polypropylene film to be coated was given a rate of travel of 100 m/minute. Obtained at the outlet of the nozzle, after establishing the continuous mode, was a continuous and cohesive film 6 of adhesive composition ensuring the production of the two-layer film.

The rate of travel was then brought to a value of 300 m/minute, then to a value of 500 m/minute while obtaining the same result as for the rate of travel of 100 m/minute.

The value 500 m/minute is indicated in Table 1 as the value of the maximum rate of travel of the film, that is to say the maximum speed for which a continuous and cohesive film 6 of adhesive composition is obtained at the outlet of the nozzle. This film 6 led to the deposition on the film 1 of a layer having a thickness of around 2 μm (corresponding to a coating weight of around 2 g/m²).

The cohesion of the composite film thus obtained was evaluated by the 180° peel tests carried out on non-heat-welded film and on heat-welded film. The results, indicated in Table 1, show a cohesion quality of the same level as with polyurethane-type adhesives.

### Examples 2 and 3

Example 1 was repeated using the compositions indicated in Table 1, the ingredients of which were blended using a blade mixer.

The results obtained are also indicated in Table 1.

### Example 4

Example 1 was repeated using the composition indicated in Table 1.

The results obtained are also indicated in Table 1.

The MFI, measured at 190° C., was 60 g/10 minutes.

Regarding the maximum rate of travel, at the rate of 300 m/minute it was found to be impossible to obtain a continuous and cohesive film 6 of adhesive composition at the outlet of the nozzle.

### Example 5

Examples 2 and 3 were repeated using the composition indicated in Table 1.

The results obtained are also indicated in Table 1. As for Example 4, a maximum rate of travel of 100 m/minute was obtained.

### Example 6

Examples 1 to 5 were repeated using a laminating machine, the structure of which corresponds schematically to the device represented in FIG. 2.

The 2 oriented polypropylene films were packaged as a reel having an width of 30 cm. The reel of polypropylene to be coated was driven by a motor making it possible to give the substrate a rate of travel ranging up to 600 m/minute. The coating device 5 comprised a lip nozzle sold by NORDSON under the reference BC 70, the slot of which had the shape of a rectangle having a length of 30 cm and a height of 600 μm. This nozzle was placed 1 mm away from the thin layer substrate to be coated.

The adhesive composition was extruded through the lip nozzle at the extrusion temperature indicated in Table 1 and at a pressure between 70 and 90 bar.

The continuous and cohesive film 6 of adhesive composition also resulted in the deposition, on the film 1, of a layer having a thickness of around 2 μm (corresponding to a coating weight of around 2 g/m²) which was pressed against said film 1 by means of the roll 7, equipped on its exterior with a non-stick coating consisting of polytetrafluoroethylene.

The lamination of the film 2 to the film 1 thus coated was carried out using the rolls 8 and 9.

Substantially the same results were obtained as those indicated in Table 1 for the maximum rate of travel and also for the 180° peel tests carried out on non-heat welded film and on heat-welded film.

TABLE 1

| | Content (%) | | | | |
|---|---|---|---|---|---|
| Ingredient | Example 1 | Example 2 | Example 3 | Example 4 | Example 5 |
| Kraton ® D1113 | 59.7 | 43.5 | 40 | — | — |
| Vector ® 4230 | — | — | — | 59.7 | 40 |
| Sylvarès ® TR7115 | 14.9 | — | 22.2 | 14.9 | 22.2 |
| Escorez ® 1310 LC | 24.9 | — | 37.3 | 24.9 | 37.3 |
| Escorez ® 5400 | — | 56 | — | — | — |
| Irganox ® 1010 | 0.5 | 0.5 | 0.5 | 0.5 | 0.5 |
| Extrusion | 200 | 145 | 195 | 200 | 170 |
| temperature (° C.) | | | | | |
| Brookfield viscosity measured | >200 000 | 20 000 | 43 000 | >200 000 | 14 000 |
| at 190° C. (mPa · s) | | | | | |
| Maximum rate of | 500 | 500 | 500 | 100 | 100 |
| travel (m/minute) | | | | | |
| 180° peel on non-heat- | 1 | 0.8 | 1.1 | 0.8 | 1.1 |
| welded film (N/cm) | | | | | |
| 180° peel on heat- | 1.8 | 1.5 | 1.6 | 1.7 | 1.8 |
| welded film (N/cm) | | | | | |

What is claimed is:

1. A multilayer film comprising at least two thin layers of material joined together by an adhesive layer, having a thickness that does not exceed 10 μm, comprising:
30 to 70% of a blend of styrene block copolymers including:
5 to 75% of a triblock copolymer comprising SIS, SIBS, SBS, SEBS or SEPS; and
25 to 95% of a diblock copolymer comprising SI, SBI, SIB, SB, SEB, or SEP,
the overall content of styrene units of said blend being between 10 and 40%; and
30 to 70% of at least one tackifying resin.

2. The multilayer film according to claim 1, wherein the triblocks copolymer and diblock copolymer present in the blend of styrene block copolymers have the same elastomer block.

3. The multilayer film of claim 1, wherein the triblock copolymer has a linear structure.

4. The multilayer film of claim 1, wherein the at least one tackifying resin has a weight-average molecular weight of between 300 and 5000 Da and is:
(i) natural or modified natural rosin;
(ii) resin comprising hydrogenated, polymerized or copolymerized (with an aromatic hydrocarbon) mixtures of unsaturated aliphatic hydrocarbons having around 5, 9 or 10 carbon atoms resulting from oil cuts;
(iii) polymerized terpene hydrocarbon resin; or
(iv) copolymers based on natural terpenes

5. The multilayer film of claim 4, wherein the at least one tackifying resin is polymerized terpene hydrocarbon resin or resin based on mixtures of hydrogenated unsaturated aliphatic hydrocarbons, polymerized mixtures of aliphatic hydrocarbons, or mixtures of unsaturated aliphatic hydrocarbons copolymerized with an aromatic hydrocarbon.

6. The multilayer film of claim 1, wherein the adhesive composition comprises 35 to 65% of the blend of triblock and diblock copolymers and from 35 to 65% of tackifying resin(s).

7. The multilayer film of claim 1, wherein the styrene block copolymer is, an SIS triblock copolymer of linear structure blended with an SI diblock copolymer.

8. The multilayer film of claim 1, wherein the thickness of the layer of adhesive composition is less than or equal to 5 μm.

9. The multilayer film of claim 1, wherein the thin layers of material have a thickness ranging from 5 to 150 μm.

10. The multilayer film of claim 1, wherein the materials used for the thin layers that are joined together comprise paper, aluminum or thermoplastic polymers.

11. The multilayer film of claim 1, wherein one of the at least two thin layers comprises a transparent material and bears, on at least one part of the face that is in contact with the layer of adhesive composition, a deposition of inks.

12. A method of continuously preparing the multilayer film of claim 1, comprising:
(i) coating a first thin layer of material with the adhesive composition, in which said composition, rendered flowable by heating at an appropriate temperature, is extruded by a coating device without contact with said thin layer, in the form of a substantially continuous layer, which is then brought into contact with the surface of said thin layer; then
(ii) laminating a second thin layer, onto the first thin layer coated in accordance with step (i).

13. The method of claim 12, wherein the substantially continuous layer of adhesive composition extruded by the coating device:
(a) crosses the space between said device and the film suspended in air, the pressure of which is locally dropped to a value between 500 and 975 mbar; then
(b) is brought into contact with the film in the vicinity of the edge formed by the two guiding surfaces and of a deflecting element through which a compressed air duct passes that opens via at least one outlet opening into the zone of the edge, so that the compressed air forced back forms a cushion of air around said edge.

14. The method of claim 12, wherein the substantially continuous layer of adhesive composition extruded by the coating device is, after it has come into contact with the film, pressed against the latter by a roll, the exterior of which is provided with a non-stick coating.

15. A manufactured flexible package comprising the film of claim 1.

16. The multilayer film of claim 4, wherein the natural or modified natural rosin is pine tree gum rosin, pine tree root rosin, or hydrogenated, dehydrogenated, dimerized, polymerized, or monoalcohol- or polyol-esterified derivatives thereof.

17. The multilayer film of claim 4, wherein the natural or modified natural rosin is pine tree gum rosin, pine tree root wood rosin, or hydrogenated, dehydrogenated, dimerized, polymerized, or glycerin-esterified derivatives thereof.

18. The multilayer film of claim 4, wherein the terpene resins are monoterpenes in the presence of Friedel-Crafts catalysts.

19. The multilayer film of claim 4, wherein the terpene resins are monoterpenes in the presence of Friedel-Crafts catalysts modified by the action of phenols.

20. The multilayer film of claim 4, wherein the natural terpenes are styrene/terpene, α-methylstyrene/terpene, and vinyltoluene/terpene.
